(19) United States
(12) Patent Application Publication
(10) Pub. No.: US 2010/0278144 A1
(43) Pub. Date: Nov. 4, 2010

(54) METHOD AND SYSTEM FOR GENERATING A SET OF TARGET CELLS SUITABLE FOR HANDOVER FROM A SOURCE CELL IN A CELLULAR COMMUNICATION SYSTEM

(75) Inventors: Henrik Olofsson, Kista (SE); Michael Roberts, Kista (SE)

Correspondence Address: Slater & Matsil, L.L.P., 17950 Preston Road, Suite 1000, Dallas, TX, 75252, US

(73) Assignee: Huawei Technologies Co., Ltd., Shenzhen (CN)

(21) Appl. No.: 12/522,504

(22) PCT Filed: Jan. 8, 2007
(86) PCT No.: PCT/CN07/00036

§ 371 Date: Mar. 5, 2010

(51) Int. Cl. H04W 4/00

(52) U.S. Cl. 370/331

(57) ABSTRACT

The present invention relates to a method for generating a set of target cells suitable for a handover from a source cell in a cellular communication system, said communication system including a plurality of cells, each of said cells including at least one radio transmitter for providing communication with at least one user entity in a coverage area. The method further comprises, in said user entity, when in a coverage area of said source cell, receiving signals transmitted from at least one of said cells, wherein said signals include cell-specific data from which a representation of a relationship of said cell with respect to said source cell can be derived, and generating a set of target cells in said user entity, based on said signals transmitted from said at least one cell. The present invention also relates to a system, a user entity, a computer program and a computer program product.

### FIELD OF THE INVENTION

The present invention relates to a method for generating a set of target cells suitable for handover from a source cell in a cellular communication system. The present invention further relates to a communication system, a user entity, a computer program and a computer program product.

### BACKGROUND OF THE INVENTION

Wireless mobile communication systems are usually cellular, i.e., the total coverage area of such a system is divided into smaller areas wherein each of these smaller areas are associated with a radio base station (Node B, eNB) having one or more radio transmitters for providing communication resources via a radio interface for communication with user entities (UE), such as mobile phones, smart phones or handheld computers having communication capabilities, located in said area. See FIG. 7. These areas are usually called cells. Two or more cells may share a base station, e.g., the base station may be provided with radio transmitters that transmit in different directions, the coverage area of each transmitter being defined as a cell. Alternatively, a single cell may comprise two or more radio transmitters for providing radio coverage in a specific area. In the simplest form of a cellular communications network, the cells are located adjacent to each other to jointly provide coverage in the geographical area that the communication system is intended to cover.

The network supports mobility by allowing the interface between the UE and the network (i.e., connection to a radio transmitter) to move by connecting the UE to different radio transmitters as the UE moves around in the network. When the UE is switched on and communicating with the network, it can be in an active or an idle state. When the UE is in an idle state, the activity of the UE is reduced to a minimum to reduce power consumption. However, the UE will regularly and/or continuously and/or at certain occasions listen to radio transmitters surrounding the radio transmitter to which the UE is presently connected in order to identify suitable surrounding (adjacent or neighbour) cells to connect to (camp on to) as it moves around in the network coverage area. In idle mode, this is called cell reselection. The UE will reselect to a new neighbour cell if it is determined that the new cell is better for service than the camped cell.

When in the active mode, the UE also regularly and/or continuously and/or at certain occasions measures suitable cells. If the UE moves from one cell to another while in the active mode, however, a simple cell reselection is not sufficient, since there is an ongoing communication and the communication channel(s) need to be relocated from the current cell (serving cell) to a suitable cell (target cell). This relocation of communication channels is called a handover. The network uses measurement reports from the UE to decide whether to do a handover or not.

In order to reduce the amount of signalling from the UE to the network regarding measurement reports of surrounding cells, a neighbour cell list is transmitted from the network to the UE. These lists are cell specific, and one purpose of the list is to define suitable target cells surrounding the serving cell. These lists are necessary since the radio environment may create situations where a cell which, based on radio quality measurements alone, appears to be the most preferred cell, may not be suitable for handover at all.

One example of such as scenario is when a UE is moving across a bridge over water between two tunnels. The UE should not connect to any cell it can receive while on the bridge, since this cell would be immediately lost again when entering the tunnel. Therefore, it would be favourable to only measure for cells broadcasting inside the tunnels.

The neighbour cell lists are transmitted, e.g., on a Broadcast Control Channel (BCCH), which is designed to cover the whole cell area. The BCCH is a common downlink channel which does not have any uplink acknowledgement channel associated with it. This means that the data must be robustly encoded and therefore consume relatively large amount of radio resources.

In fact, there is a risk that in some cases that the transmission of the neighbour list may consume too many of the available resources for one cell. One example of this is the current 3rd Generation Partnership Program (3GPP) work on defining a future cellular communication system, presently called the Long Term Evolution (LTE), in which system only a small bandwidth may be used in a cell, for example 1.25 MHz. Apart from the small bandwidth, these cells are usually small, with a lot of surrounding cells being potential target cells, In such situations, the neighbour cell list may be extensive, which thus further increases the bandwidth usage for the list.

Therefore, there exists a need for a system wherein the neighbour cell list data is communicated to the UE without any significant loss of information in a more efficient manner in order to reduce the use of the cell communication resource capacity, in particular for low-bandwidth cells.

### SUMMARY OF THE INVENTION

It is an object of the present invention to provide a method for generating a set of target cells suitable for a handover from a source cell in a cellular communication system that solves the above mentioned problem.

It is a further object of the present invention to provide a communication system that solves the above mentioned problems.

According to the present invention, a method is provided for generating a set of target cells suitable for a handover from a source cell in a cellular communication system, said communication system including a plurality of cells, each of said cells including at least one radio transmitter for providing communication with at least one user entity in a coverage area. The method comprises the steps of, in said user entity, when in a coverage area of said source cell, receiving signals transmitted from at least one of said cells, wherein said signals from said cell include cell-specific data from which a representation of a relationship, such as a relative location, of said cell with respect to the source cell can be derived, and generating a set of target cells in said user entity, based on said signals transmitted from said cells.

This has the advantage that no signalling of neighbour cell lists by cells in the communication system is required, since corresponding data is determined by the user equipment itself. Consequently, the present invention allows a reduction of data transmitted from cells in the system, in particular in areas wherein the possible number of neighbour cells, and thereby the extent of the lists, is large, since, instead of transmitting the neighbour cell list in all cells, each cell only needs to provide information about itself. In an alternative embodiment, cells in the system can, apart from providing information about themselves, also provide some limited information about other cells, e.g., frequency information or whether certain cells are restricted from use. A said relationship can consist of any description of how the cells relate to each other. If the relationship is a relative location, the relative location can, for example, consist of a physical distance, a parameterized distance, a distance in a representation of cells in the system, such as a map or pattern (which will be described further below).

In one exemplary embodiment of the present invention the physical cells are represented by a cell pattern, and cells in the system are allocated a position in the cell pattern. The user equipment is then, based on information from the cells, able to deduce which cells are neighbour cells by knowing this pattern and extracting the position allocated to the camped cell in said pattern, and create a list of suitable cells, similar to what is done in the neighbour cell list. If cells also provide information about other cells, this information can, for example, consist of information about which pattern that is used in these cells, and the positions of the cells in the pattern.

Another exemplary solution according to the present invention is to allow cells to transmit their geographical coverage coordinates in a defined coordinate system. The UE can then read this information from signals received from cells and thereby create a geographical model of its camped cell and the neighbouring cells. Using the model, the UE is then able to determine the neighbouring cells.

The present invention is applicable to any type of mobility, i.e., for mobility among cells using the same frequency and also for cells using another frequency as well as cells supported by another radio access technology.

Further characteristics of the present invention and advantages thereof, will be evident from the following detailed description of preferred embodiments and appended drawings, which are given by way of example only, and are not to be construed as limiting in any way.

### BRIEF DESCRIPTION OF THE DRAWINGS

FIG. 1 discloses an example of a Long Term Evolution (LTE) system in which the present invention may advantageously be utilised.

FIG. 2 discloses an example of a parameterized cell pattern according to the present invention.

FIG. 3 discloses an example of another cell pattern according to the present invention.

FIG. 4 discloses an example of a repetition of a cell pattern.

FIG. 5 discloses an exemplary pattern and assigned cell pattern values for an examplary scenario with different cell sizes.

FIG. 6 discloses different usage of the cell pattern values in different frequencies due to different cell sizes.

FIG. 7 discloses an exemplary system according to an embodiment of this invention.

FIG. 8 discloses an exemplary user entity according to an embodiment of this invention.

### DETAILED DESCRIPTION OF PREFERRED EMBODIMENTS

In the description of the present invention, the term “handover” is intended to include not only a handover in an active mode, i.e., handover of one or more communication channels, but also the situation when a user entity (UE) in an idle mode performs a cell reselection. Further, the term “serving cell” is intended to comprise not only the cell a UE in the active mode has an ongoing communication with, but also the cell a UE is camped on when in an idle mode.

As stated above, the 3rd Generation Partnership Program (3GPP) Radio Access Network (RAN) working groups (WG), which have defined the UMTS Universal Terrestrial Radio Access Network (UTRAN), is currently working on defining a future cellular communication system in the Long Term Evolution (LTE) Work Item (WI).

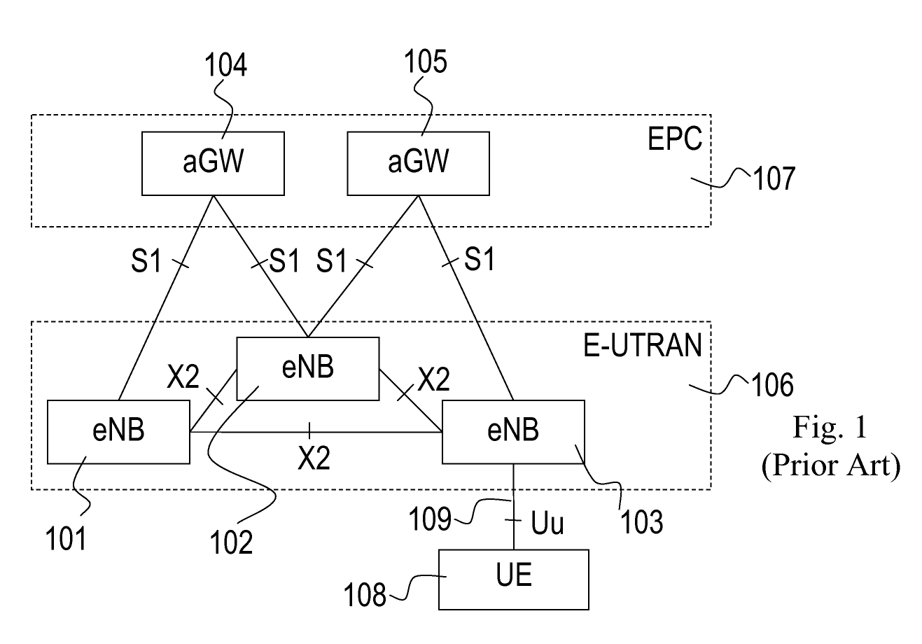

An example of the architecture of an LTE system 100 is shown in FIG. 1 and consists of two kinds of nodes, eNB 101-103 and aGWs 104-105, where the eNBs 101-103 belongs to the evolved UTRAN (E-UTRAN) 106 and the aGW belongs to the evolved packet core (EPC) 107. A user entity (UE) 108 connects to the network (E-UTRAN and EPC) by means of a radio interface, Uu interface 109. The eNB 101-103 handles communication over the radio interface in a certain coverage area, i.e., a cell, which is the area wherein the radio signal is strong enough to allow a satisfactory communication with UEs within this area.

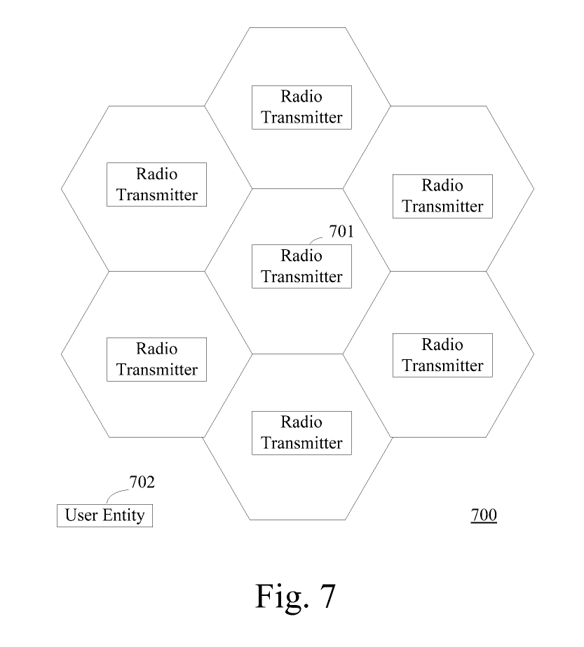

When the UE 108 moves around in the coverage area provided by the communication system (FIG. 7), the UE 108 will move from one cell to another, and thereby an ongoing communication will be transferred from the eNB to which the UE presently belongs, i.e., the serving cell, to the cell into which the UE is entering, i.e., the target cell. This is accomplished by establishing a communication channel on the Uu interface of the target cell, and terminating the communication channel on the Uu interface of the source cell.

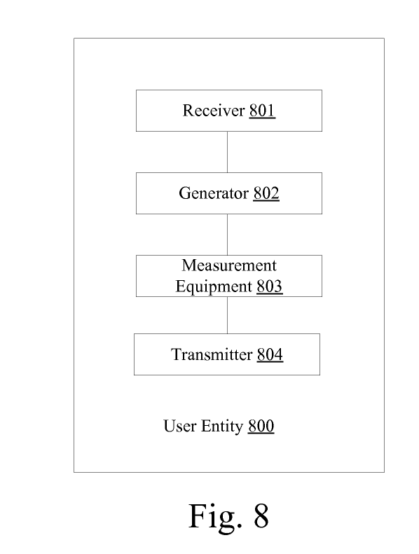

The target cell is selected based on measurements of potential target cells performed by the UE (Measurement Equipment 803 of FIG. 8), which measurements are transmitted to the eNB for processing by the system (via Transmitter 804). The target cells that are classified as “potential” are defined in a neighbour cell list, which is transmitted to and received by Receiver 801 at UEs within range of the eNB on a radio channel. As stated above, there exits a desire to reduce the transmission of information associated with the transmission of neighbour cell lists.

Further, in an idle mode of operation the UE does not transmit any measurement reports to the eNB, and no explicit signalling is required when the UE is changing cells, at least not as long as it is moving around within a tracking area. However, the need for neighbour cell lists in the idle mode can still be similar to then when the UE is in the active mode.

According to the present invention, a method is provided that allows the neighbour cell list information to be created in the UE, in the active and/or idle mode, without the need for transmitting such lists of surrounding, or neighbouring, cells from each cell in the system. This is accomplished by a system wherein the cells, instead of transmitting neighbour cell lists, transmit cell-specific information that includes data from which a representation of its location can be derived. This representation may, e.g., constitute of a location in a cell pattern, a geographical location, and/or a description of the cell coverage area. This has the advantage that a set of suitable target cells can be derived by the UE in a system wherein the cells only need to transmit cell-specific data.

In a first exemplary embodiment of the present invention, the representation of cell location is given by a cell pattern based solution that is used to enable the UE to determine suitable target cells. In this solution, the locations of the cells are represented by a cell pattern that describes the relative location of cells in the system with respect to each other. Each cell transmits data, which the UE can use to determine the relative location and identity of the cell with respect to the source cell and/or other cells in the system. This data may, for example, constitute a “cell pattern value”, i.e., a value that represents the specific location or position of a cell within a cell pattern. This cell pattern value can, e.g., be transmitted on a downlink common channel or any other suitable channel, as long as it is possible to decode data transmitted on the channel by UEs currently camping in neighbouring cells. For example, the cell pattern value could be sent on BCH or any broadcasted channel (for example SCH). In the following, it is assumed that the cell pattern value is sent in, e.g., a Layer 2 message sent in messages on BCCH.

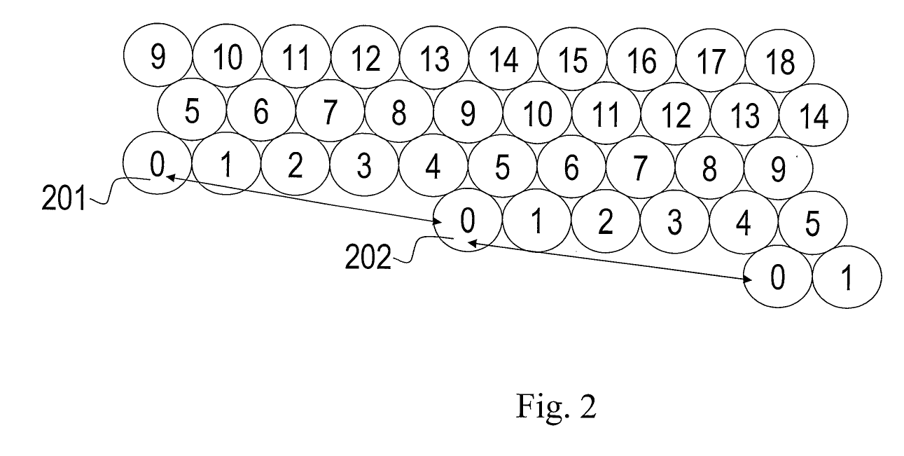

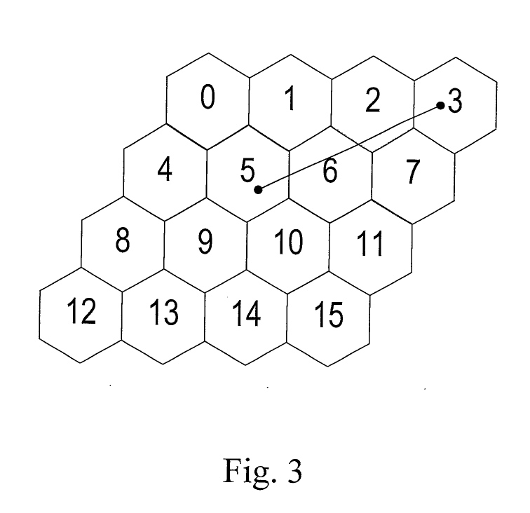

The cell pattern value is assigned to the cell from a set of cell pattern values defined in a specific cell pattern, which indicates the relative relationship between different cell pattern values. The cell pattern, in turn, may be different in different parts of the network, and can, e.g., be identified by a cell pattern ID, from which the UE can determine the layout of the cell pattern, or a cell pattern description, from which the UE is capable of recreating the cell pattern. Examples of such patterns are shown in FIGS. 2-3, which will be described more in detail below.

In operation, at least in the active mode, the UE may regularly and/or continuously and/or at certain occasions search for neighbouring cells. When the UE finds a new cell, it decodes the “cell pattern value” for the cell. The UE can use this information to determine a representation of the location of the new cell with respect to the currently camped cell using said cell pattern. For example, the cell pattern value can be used to determine a distance between the currently camped cell and the new neighbour cell. Since the pattern is a schematic representation of actual locations of cells, the determined distances can constitute distances in the pattern and need not constitute actual distances between the actual cells in the system. The cell pattern value can, e.g., be explicitly signalled by each cell, i.e., if the cell pattern comprises 16 positions, or cell locations, the cells belonging to said cell pattern can signal a four bit value indicating the position of the cell in the cell pattern.

Alternatively, the cell pattern value can be implicitly signalled by, for example, mapping another broadcasted value to a certain cell pattern value. Assuming that the cellular system is using some form of cell identifier, cell-ID, one example of implicit signalling is to group these cell identifiers into groups where each group points to a specific cell pattern value. The UE then only needs to decode the cell identity to be able to derive the cell pattern value of a particular cell. This mapping of the cell-IDs to cell pattern values can, for example, be static and stored in the UE. Alternatively, the system can signal the relationship at the entering of a new cell pattern area, i.e., an area in which a certain cell pattern is valid.

In the prior art, the cell-ID is often coded in such a manner that it is immediately retrievable for a UE that has detected a cell in order to allow a fast cell identification. For example, in LTE the cell-ID can be coded so that the UE only needs to decode the synch channel (SCH) to retrieve cell-ID, wherein the cell-ID is implicitly coded as one of a plurality of reference sequences on the SCH.

According to the present invention, the cell pattern value can be mapped onto said cell-ID, i.e., by determining the cell-ID, and the UE will immediately know the cell pattern value of the cell. This has the advantage that a very fast determination of the cell pattern value can be obtained. Further, if a cell belongs to more than one pattern, a situation which will be described more in detail below, the two or more pattern-IDs can be mapped onto the cell-ID.

As mentioned above, the cell pattern valid for a certain cell must be available in the UE. An exemplary solution is to define only one cell pattern in the communication system specifications, i.e., to use a single cell pattern throughout the system. This solution, however, may not always be the most suitable since although a specific cell pattern may be suitable for certain arrangements of cells, the environmental variations, e.g., due to topology and/or whether it is an urban or countryside area, impose condition variations, such as UE density, that can require rather different arrangements of the radio transceivers (cells). Therefore, a solution that is more adaptive to varying conditions is to predefine a set of cell patterns and signal an index identifying which cell pattern to use. For example, there may be eight different cell patterns that are used in the system, and the specific cell pattern to use may then be transmitted using a three bit representation. Alternatively, the cell pattern can be parameterized, i.e., be described by parameters, in which case the parameters are sent to the UE so that the UE can recreate the cell pattern from the parameters.

For example, the following parameters can be used to define a cell pattern:

Row offset, and

Maximum cell pattern value.

An example of a parameterized cell pattern is illustrated in FIG. 2. In the disclosed example, the cell pattern is created by a Row offset of 4.5 and a Maximum cell pattern value of 18, i.e., the cell pattern is created by putting rows together, each row being 18 positions long, and the next row starting with an offset of 4.5, i.e., the start of row 202, is offset 4.5 positions with regard to row 201 (as can be noted in the figure, no row is shown in its entirety). If, as in the figure, the cell pattern is used in a great number of cells, i.e., the cell pattern is duplicated a number of times, the end of one row is immediately followed by a new row (not shown).

Another example of parameter use is shown in FIG. 3. In this example, the cell pattern is given by the parameters “Geometrical shape” and “size”, with the values:

Geometrical shape: rhombic, and

size 4*4, i.e., the cell pattern consists of 16 positions arranged as a rhombus.

The cell pattern-ID or cell pattern parameters may be signalled in every cell. It is, however, beneficial if the same cell pattern is defined for multiple cells in order to reduce the signalling in the system.

This signalling may, e.g., be triggered by UE mobility. One example of this is to keep the same cell pattern within a certain area of the communication system, e.g., a tracking area (location area), and only update the current cell pattern and/or cell pattern parameters if the UE moves to another area of the communication system, e.g., another tracking area, that has a different cell pattern.

It may be advantageous to always use the same cell pattern, at least inside each tracking area. This is so because the UE, when in the idle mode, only reports to the network when changing the tracking area. The cell pattern can be updated when changing tracking area in a simple manner, e.g., in the tracking area update response message.

The object of the cell pattern is to make possible for the UE to perform a distance calculation based on cell pattern values and the cell pattern description. In one embodiment, a predefined table of distances is used to determine distances between different cell pattern values for a given cell pattern.

The ability to resolve distances is related to the size and shape of the of the cell pattern. For example, the cell pattern according to FIG. 3 is defined with cell pattern values in a range from 0 to 15. Transmitting the cell pattern value requires 4 bits. In this cell pattern, it is relatively easy to calculate a representation of the distance between two cell pattern values, for example (cell) 5 and (cell) 3.

As can be easily understood, the disclosed embodiment can be used to determine that, in an example wherein a UE is presently camped in cell 5, the cells 0, 1, 4, 6, 9, 10 are more suitable for handover than cells further away from cell 5, such as cell 3. Accordingly, this determination can be made even though no information regarding physical cell size, e.g., cell radius, is transmitted. Consequently, the UE can use the cell pattern to determine which cells are more suitable for handover than others, and, based on measurements from surrounding cells and the cell pattern, determine suitable cells for handover, which cells then can be transmitted to the network for further processing, e.g., determination of a cell to which the UE finally is to be handover to. The UE thus creates a neighbour cell list on its own, based on information received from signals transmitted from serving cell and surrounding cells.

In the above example, each cell in the communication system, or tracking area, is provided with a unique cell pattern value. In larger systems, however, the cell pattern may, as described in connection to FIG. 2, be repeated, and thereby multiple copies of each cell pattern value can exist in the system.

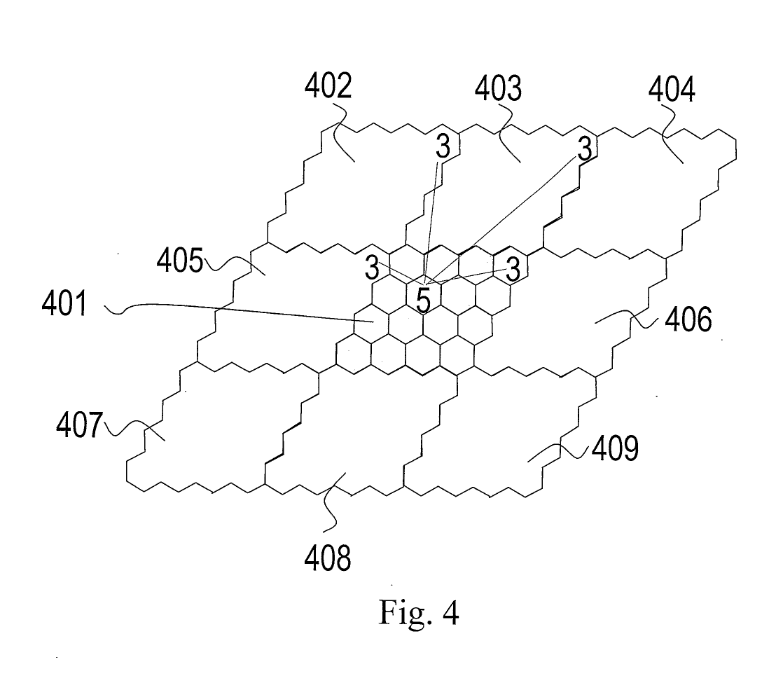

This is exemplified in FIG. 4, wherein the cell pattern in FIG. 3 is repeated a number of times, and exist as cell pattern 401, 402, . . . 409. When calculating the distance, the closest repeated copy of the cell pattern value shall be considered. For example, in the disclosed cell pattern, the distance between cell pattern value 5 of cell pattern 401 and repeated copies of cell pattern value 3 of cell patterns 402, 403, 405 is shown. As can be seen in the figure, the distance to the cell pattern value 3 of cell pattern 405 is smaller than the cell pattern value 3 of cell pattern 401. Consequently, if the set of potential target cells in the UE is to include more than the cells closest to cell 5 of cell pattern 401, i.e., the cells 0, 1, 2, 4, 6, 8, 9, 10 of cell pattern 401, cell pattern value 3 of cell pattern 405 should be added to set and not cell pattern value 3 of cell pattern 401.

If the radio planning has been performed in a correct manner, the UE may safely assume and consider the immediate neighbour cells as being suitable cells.

The network may also send a parameter indicating how many of the detected cells that are to be considered as suitable target cells. This may, e.g., be accomplished either by signalling a specific number of cells, assuming an ordered list with the cells with smallest distance first, or signalling the maximum distance for suitable cells, e.g., the cells closest to cell pattern value 5 in cell pattern 401 of FIG. 4.

The basic principle of cell patterns according to the above has assumed a relatively homogeneous cell size. This may not always be the case, e.g., the cell size may be smaller in urban areas than in sparsely populated areas, and/or vary due to obstacles such as tall buildings.

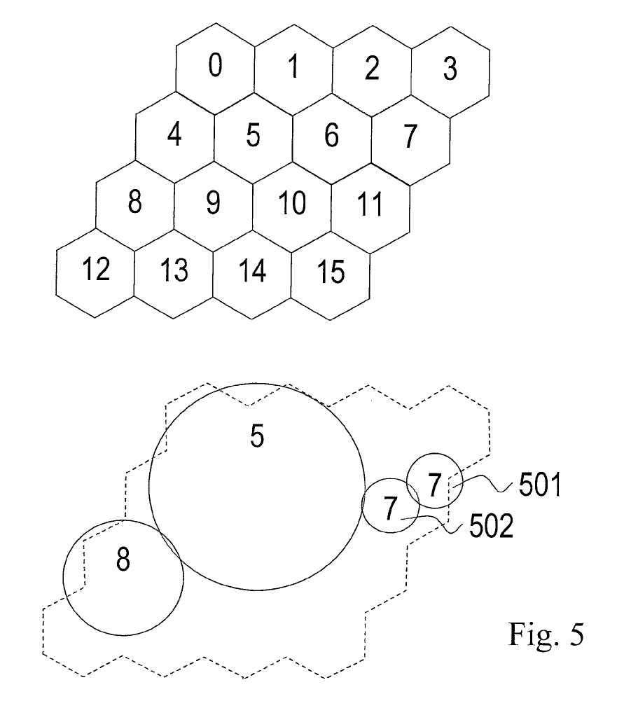

If different cell sizes are used, it may be necessary to adjust the cell pattern to account for these differences. For example, if some of the cells are very small, the same cell pattern value may be assigned to more than one neighbouring cells if these cells together correspond, or partially correspond to the cell size of a cell according to the cell pattern. This is illustrated in FIG. 5, wherein the cells 501, 502 both have been assigned cell pattern value 7.

Further, if one or more cells are considerably larger than a “normal” cell of a cell pattern, some of the values in the cell pattern may not be used at all. This is also illustrated in FIG. 5, wherein the cell with cell pattern value 5 covers a much larger area than it should according to the cell pattern. In this case, no cells will be assigned the values 0, 1, 4, 6, 9, 10, and the cell with value 8 will be a neighbour cell, although it will not be perceived as an immediate neighbour, unless the UE is provided with some additional information.

This could be solved by cell-specific signalling to adjust for the difference in coverage area. In the above example, the cell having cell pattern value 5 could signal that it is relatively larger, meaning that the distance to neighbouring cells will be larger. If no explicit diameters are signalled, the cell 5 could, e.g., signal a radius factor, e.g., 3, which means that the cell 5 have a radius three times the radius of a “normal” cell of the cell pattern. Thereby, the UE can conclude that the cell 8 will be an immediate neighbour to the cell 5, at least if no cells with cell pattern numbers 4 or 9 are present. Alternatively, the radius in it self could have the meaning that the enlarged cell covers all other cell pattern values within the given radius, e.g., that, in the disclosed example, the cell with cell pattern value 5 geographically covers also the “ring” of closest neighbour cell pattern values, and that these cells are not present. Should the radius be even larger, the cell could, e.g., cover X “rings” of closest neighbour cell pattern values.

Alternatively, the cell 5 could transmit cell pattern values of all cells it is covering, e.g., 0, 1, 4, 5, 6, 9, 10 so as to allow the UE to conclude that the cell 8 actually is a neighbour of cell 5.

In a similar way, the two cells with cell pattern value 7 could signal that they are relatively smaller, meaning that the distance to neighbouring cells will be smaller.

Another solution in a situation according to FIG. 5 is to let the UE determine the actual cell pattern without additional signalling from the cells. A UE could do this by analyzing the received cell pattern values and determine if there are relatively fewer pattern values representing close neighbours. If so, the UE may conclude that a cell lacking immediate neighbours is relatively larger.

So far, it has been assumed that all cells communicate in the same frequency (frequency band). There are, however, situations where the cellular system may be using different frequencies (frequency bands). Such situations may, e.g., be frequently occurring in urban areas, where different cell sizes may be used on different frequencies. Small cells are beneficial since use of many small cells can increase system capacity. Small cells, on the other hand, are not advantageous for UEs moving around in the system with high velocity, since this would require frequent handovers to maintain ongoing communications in the network.

Similar to the current solution for UTRAN, the UE should be informed about frequencies (frequency bands) on which there may be neighbouring cells. In addition to this, the UE may also be informed about which cell patterns are used on the different frequencies.

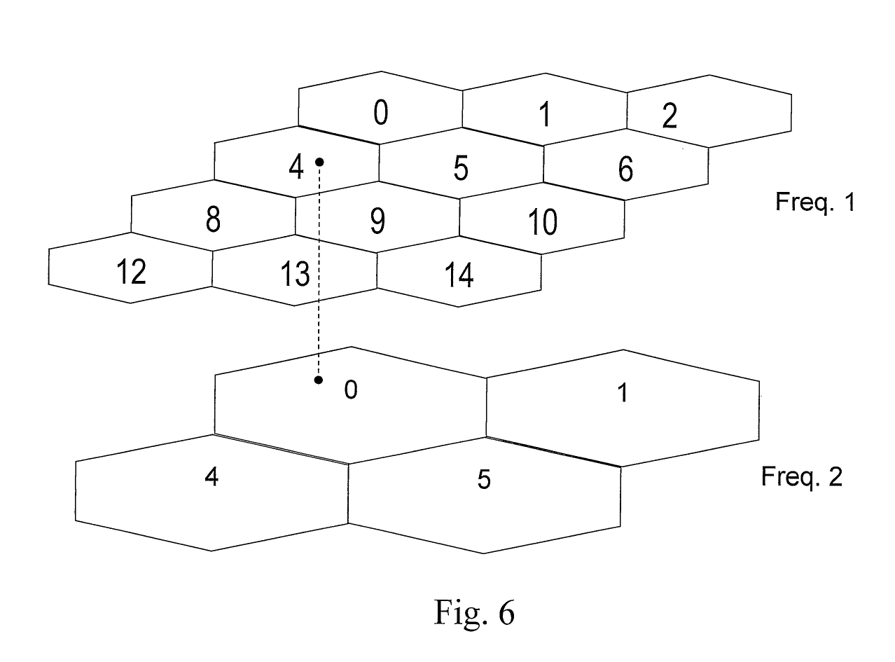

When different cell sizes are used on different frequencies, usage of cell pattern and/or cell pattern values may be different in the different frequencies. Further, geographically overlapping cells may inherently have different cell pattern values even if the same cell pattern is used in the different frequencies, due to different cell sizes. This is illustrated in FIG. 6, wherein the cell pattern of FIG. 3 (only partly shown) is used in two different frequencies, frequency 1 and frequency 2. As can be seen in the figure, the cell 4 of frequency 1 corresponds to cell 0 of frequency 2. Conversely, the coverage area of a cell of frequency 2 corresponds to a plurality of cells of frequency 1. In order for the UE to understand it's location in other frequencies than the frequency it is presently located in, when determining the distance to cells of other frequencies, the eNBs can preferably also transmit “secondary cell pattern values”. These secondary cell pattern values represent the cell pattern value or values of the cell(s) of other frequencies that have a coverage area that at least partially corresponds to the coverage area of the cell transmitting the secondary cell pattern value(s).

These secondary cell pattern values may or may not be signalled to the UE in the same way as the cell's own pattern value. The secondary cell pattern value of a particular cell will normally only be decoded by UEs that presently camp on this cell, but preferably the secondary cell pattern values are possible to decode by users camping on neighbouring cells as well.

As mentioned above, the system may assign different cell patterns to different frequencies. If so, the UE must be informed about the cell patterns of the other frequency or frequencies. This can, for example, be done by:

Including information about all frequencies and sending the multiple cell patterns, e.g., as was described above in relation to signalling the cell pattern, or

Only informing the UE in situations when inter-frequency measurements are suggested by the network (this solution is only applicable for UEs in the active mode).

To find inter-frequency neighbours, a possible way is to apply the same numbering patterns to cells on all frequencies and to use techniques described above to handle the different cell sizes of different layers.

So far, the invention has mostly been described for a system, or parts of a system, wherein the cell pattern, at least within a layer, is homogenous. As mentioned earlier, however, usage of the cell pattern can be different on the same frequency in adjacent areas, e.g., adjacent tracking or location areas. Although similar solutions as described above can be used to manage any differentiated use of cell patterns in adjacent areas, there exists an additional problem in that when only the cell pattern value is transmitted, it is not immediately possible to determine which cell pattern each cell pattern value belongs to. Above, the UE measures different frequencies, and each frequency may have a different usage. In this case, the UE measures one frequency and the usage for each detected cell may be different.

One exemplary solution is to carefully plan the usage of cell pattern values in the border area and let the UE calculate the distances for all possible cell patterns for each detected cell. In an area close to where the cell pattern is modified, the UE will receive multiple cell patterns from the serving eNB. The UE is also informed of the cell pattern value for the serving cell in each of these cell patterns. The UE can then calculate the distance to all detected cell pattern values, for all the different cell patterns. This has as result that a specific cell can appear to be closer or further away depending on which cell pattern it is assumed to belong to. In an exemplary embodiment, the shortest of the calculated distances is used.

Another exemplary solution is to let each cell signal which cell pattern it is using. A UE that detects a neighbouring cell then has to decode both the cell pattern value and the cell pattern for each cell in order to perform the distance calculation.

As a further example, border cells can transmit a regular neighbour cell list, e.g., explicitly including just those cells that are part of another cell pattern.

In the following, an additional advantage of the present invention will be described. In the prior art, instead of only listing suitable cells, it is also possible for a network to inform the UE of unsuitable cells, in which case perform appropriate measurements on detected cells other than the unsuitable cells. In UTRAN, each restricted cell is signalled by its full cell ID.

The present invention is also applicable in such a system. According to the cell pattern based solution of the present invention, the cell pattern value of the restricted cells can be transmitted by the network. This has the advantage that the amount of information transmitted to the UE is reduced.

It may, however, be necessary to restrict a specific cell that is relatively far away. In some cases, e.g., in a system as described in FIG. 3, this mean that a repeated value of the cell pattern value at a closer distance may occur, i.e., if only the cell pattern value is used to restrict a cell also one or more suitable cells can be restricted.

A solution to this is to create a new identity, restrict-ID, which is based on a combination of the cell pattern value and the full cell-ID. For example, the restrict-ID can be formed by concatenating the cell pattern value and the least significant bits (LSB) of the cell-ID.

If the method of implicitly signalling the cell pattern value by grouping the cell-ID into groups as described above, another example of this combination is be to further divide each group into subgroups. The restrict-ID can then consist of the cell pattern value and the subgroup.

Hitherto, the present invention has been described for a single radio access technology (RAT), but the methods described above can also be used when implicitly generating a neighbour cell list for cells using another radio access technology (RAT). One way of accomplishing this is, in addition to describing the availability of cells on other frequencies, also indicating which RAT(s) is available on which frequency.

The other RAT must, of course, also provide a cell pattern value for each cell. One simple solution to this is to assume that this is implicitly signalled with the cell-ID. This solution requires no change in the information broadcasted by the other systems. The cell patterns and the usage of these would be similar to what has been described in connection to a system using different frequencies above.

Further, if a combination of different of RATs and HCS is used, similar methods as described for an HCS system above can be utilized.

Instead of using cell patterns for determining distances to surrounding cells, another exemplary solution is to allow cells to transmit their geographical coverage coordinates in a defined coordinate system. The UE can then read this information from signals received from the cells and thereby create a geographical representation such as a model or map of its camped cell and the neighbouring cells. The UE can then, using this representation, determine which cells have overlapping coverage areas and, consequently, which cells that are neighbour cells.

Information describing the coverage area is transmitted in all cells. The coverage area may be described in various ways, e.g., by a set of coordinates outlining the shape of the covered area. This solution however, may require unnecessarily large quantities of information, and to reduce the amount of transferred information, another exemplary solution is to describe the coverage of the cell by defining the coordinates of the centre of the area, and possibly also one ore more of the following:

The shape of the cell,

The radius,

The vertical coverage of the cell.

The shape can, e.g., be divided into typical cell shapes, for example omni, 3-sector and 6-sector. This may be transmitted by signalling an index, pointing to an entry in a predefined table.

The radius and the vertical coverage may either be transmitted as is, or transmitted by signalling an index pointing to an entry in a predefined table comprising a set of predefined radiuses and/or altidistances.

The UE needs to know its own location in order to calculate the distance to neighbouring cells. In an exemplary solution, the UE is assumed to be located in the centre of the currently serving cell.

As an alternative, the position of the UE can be further refined by listening to neighbouring cells. The UE can, for example, estimate the path loss to these cells and assume that it is closer to a cell with smaller path loss.

Another alternative is to use information about cells of another frequency. This is particularly advantageous in scenarios where the cells on another frequency are smaller than the cells on the current frequency, so that UE can determine in which part of the current cell it is residing by determining which of cells of the other frequency it is closest to.

Naturally, it is also possible to improve the positioning by using an external or built-in device of a positioning system, e.g., a GPS receiver.

When determining the distance to a neighbouring cell, The UE may calculate the distance from the present location of the UE to, e.g., the closest point of the described coverage of the neighbouring cell, or the cell centre. The UE may use the distance to each cell to generate a list of suitable neighbours in the same way as has been described above.

It may be advantageous to further reduce the amount of geographic information transmitted by each cell. One way of doing this is using a repeated coordinate system to reduce the value range of the coordinates.

This requires that the distance calculation takes this into account in the same way as in the pattern based solution by always considering the distance to the closest repeated copy of a certain coordinate in the repeated coordinate systems.

For example, a method of reducing the transmitted data is to use a commonly used coordinate system and not transmit the most significant bits. This type of simple mapping would also simplify the usage of coordinates derived by external devices.

Further, the amount of information can also be reduced by reducing the accuracy of coordinates, e.g., not transmitting the least significant bits.

Another option is to transmit the most significant bits and/or least significant bits on a separate channel. These may not be required to decode by a UE performing cell search, but may be used by UEs currently camping in the cell.

For other frequencies, the network may tell the UE on which frequencies there may exist neighbour cells. If HCS is used, the network can signal which frequency belongs to which HCS layer. If multiple layers are used on one frequency, the network can group different cell sizes into different layers and signal rules for this grouping to the UE. When the UE has found one cell and determined its cell size it can itself group the cells into the correct layer.

The network may signal which RAT are available at which frequencies. Similar to above, the network may inform the UE either which HCS layer these belongs to, or the mapping between cell size and layer. Use of this solution for other RAT requires that the cells of the other RAT also transmit their geographical coordinates.

In the above description, methods for generating a neighbour cell list in a UE have been described. It may, however, be advantageous that this generation of lists is checked and/or optimised by the network. When a UE builds its own neighbour cell list, only the cells considered as suitable on that list will be reported in measurement reports to the network. Also, the information in the measurement report is normally limited to values like signal strength and quality of the current radio link. For example, the UE may signal those cells that have a signal strength exceeding a certain value, or cells that are determined (using any of the above described methods) to be within a predetermined distance from the UE and/or serving cell.

In order for the network to check that the UE has built a correct neighbour cell list, and also for the network to be made aware if the UE can detect additional cells, wanted or unwanted, the network may request a special report from the UE. The UE then reports either all cells it can detect, or just those fulfilling certain criteria. Furthermore, the network may request the UE to report different values, e.g., Cell-ID, cell pattern value, geographical coordinates, calculated cell distance etc.

Based on these reports, the network may change its broadcasted values, correcting and optimising the performance, e.g., the cell pattern value for a cell might have been set in a non-optimal way in the network so that the UE calculates a too large or too small cell distance, removing or adding the cell to the neighbour list erroneously.

It can also be made possible for the network to request the UE to report the cell identities of the currently restricted cells. This has the advantage that in a situation where a compressed method of signalling the restricted cell is used, for example restricting a cell pattern value so that the restriction may be ambiguous, possibly leading to the UE also restricting other cells than the one originally intended by the network, the network may still receive measurements on cells that in fact is suitable after all, although classified as restricted.

This reporting method can also be used for self-configuration of the network, e.g., when introducing a new cell into the network, the new values (e.g., cell pattern value or geographical data) need to be set. Either a first best guess value can be set (like a default value) or a specific initial value only used for the initial configuration phase. The network will then request the UEs to include this cell in reports. From these reports the network may determine a suitable value for the parameter (e.g., cell pattern value) before the cell is actually put in a state where it can carry traffic. When the cell has been taken into use and carries traffic, the parameter can be optimized as mentioned earlier.

In the above description, the use of neighbour cell lists in the prior art, i.e., transmitting the lists from each cell in the system, have been completely omitted. There are, however, situations when a combination of the prior art and the present invention may advantageously be utilized. For example, in border areas, e.g., between countries and/or areas using different patterns according to the above, and neighbour cell lists can be transmitted in the border area cells to ensure proper operation. In other situations, the actual geographical cell pattern may be so irregular that no meaningful pattern can be accomplished in an efficient manner. It can be advantageous to utilize a combination of the prior art system and the present invention in such situations also.

### EXAMPLARY EMBODIMENTS

1. A method for generating a set of target cells suitable for a handover from a source cell in a cellular communication system, said communication system including a plurality of cells, each of said cells including at least one radio transmitter for providing communication with at least one user entity in a coverage area, wherein the method further comprises the steps of:
in said user entity, when in a coverage area of said source cell:
receiving signals transmitted from at least one of said cells, wherein said signals from said cell include cell-specific data from which a representation of a relationship of said cell with respect to the source cell can be derived, and
generating a set of target cells in said user entity, based on said signals transmitted from said at least one cells.

2. The method according to embodiment 1, wherein said signals include data from which a relative location of said cell with respect to said source cell can be derived.

3. The method according to embodiment 1, wherein said location of said cells are represented by a cell pattern, said cell pattern describing the relative location of said cells with respect to each other.

4. The method according to embodiment 3, wherein said signals transmitted from said cells comprise information from which the position of said cells in said cell pattern can be derived.

5. The method according to embodiment 4, wherein said information comprise an identity, said identity representing the position of said cells in said cell pattern.

6. The method according to embodiment 5, wherein said identity is mapped onto a cell-ID, so as to allow said identity to be determined by determining said cell-ID.

7. The method according to embodiment 6, wherein said cell-ID is coded so that it is immediately decodable when said cell is detected by said user entity.

8. The method according to embodiment 6, wherein said cell-ID is coded as a sequence on a synch channel.

9. The method according to embodiment 5, wherein said identity is cell specific within said pattern.

10. The method according to any of the embodiments 3-9, wherein said pattern is reused so that that the pattern is repeated a plurality of times.

11. The method according to embodiment 3, wherein a representation of said cell pattern is signalled by at least one of said cells, so as to allow said user entity to determine the specific cell pattern to which one or more cells belong.

12. The method according to embodiment 3, wherein said cells belong to at least two different cell patterns, and that identities of the cell patterns to which a specific cell belongs is signalled to said user entity.

13. The method according to embodiment 12, wherein said identities is mapped onto a cell-ID, so as to allow said identities to be determined by determining said cell-ID.

14. The method according to embodiment 12, wherein a single cell belongs to two or more cell patterns.

15. The method according to embodiment 12, wherein said cell patterns constitute cell patterns of more than one cellular communication system.

16. The method according to embodiment 12, wherein said cell patterns constitute cell patterns with cells of different frequencies.

17. The method according to embodiment 12, wherein said cell patterns at least partially overlap geographically.

18. The method according to embodiment 12, wherein the cell transmits its position in each pattern.

19. The method according to embodiment 3, wherein said cell pattern comprise cells of different sizes.

20. The method according to embodiment 1, wherein said set of target cells is ordered, said ordering being based on the suitability of said cells as a new serving cell.

21. The method according to embodiment 20, wherein the number of cells in said ordered set of target cells is limited.

22. The method according to embodiment 21, wherein the number of cells in said set is limited by the communication system.

23. The method according to embodiment 21 or 22, wherein the number of cells in said set is limited by defining the maximum number of cells in the set and/or defining the maximum allowed distance to cells in the set.

24. The method according to embodiment 1, wherein said set of target cells is a neighbour cell list.

25. The method according to embodiment 1, wherein the method further comprises the step of, in said user entity: performing measurements on at least a subset of said set of target cells; and transmitting said measurements to said serving cell.

26. The method according to embodiment 1, wherein said signals include information regarding the geographical coverage area of said cells.

27. The method according to embodiment 26, wherein said information include one or more from the group: the shape of the cell, the radius of the coverage area of the cell, the vertical coverage of the cell.

28. The method according to embodiment 26, wherein said information includes a representation of the geographical location of a radio transmitter of each of said cells.

29. The method according to embodiment 26, wherein said representation of the geographical location of each of said cells is an absolute position of a radio transmitter of each of said cells.

30. The method according to embodiment 1, wherein said generated set of target cells contains cells of more than one cellular communication system.

31. The method according to embodiment 1, wherein said generated set of target cells contains cells of more than one cellular radio access technology.

32. The method according to embodiment 1, wherein said user terminal is in idle or active mode.

33. The method according to embodiment 1, wherein it further comprises the step of: transmitting said generated set of target cells to said serving cell.

34. The method according to embodiment 1, wherein it further comprises the step of: selecting one of said cells of said generated set of target cells as a new serving cell.

35. A system for generating a set of target cells suitable for a handover from a source cell in a cellular communication system, said communication system including a plurality of cells, each of said cells including at least one radio transmitter for providing communication with at least one user entity in a coverage area (FIG. 7), wherein the system further comprises means for:

transmitting signals from at least one of said cells, wherein said signals from said cell include cell-specific data from which a representation of a relationship of said cell with respect to the source cell can be derived, so as to allow generation of a set of target cells in a user entity, based on said signals (FIG. 8).

36. The system according to embodiment 35, wherein said signals are arranged to include data from which a relative location of said cell with respect to said source cell can be derived.

37. The system according to embodiment 35, wherein said location of said cells is arranged to be represented by a cell pattern, said cell pattern describing the relative location of said cells with respect to each other.

38. The system according to embodiment 37, wherein said signals transmitted from said cells are arranged to comprise information from which the position of said cells in said cell pattern can be derived.

39. The system according to embodiment 38, wherein said information is arranged to comprise an identity, said identity representing the position of said cells in said cell pattern.

40. The system according to embodiment 39, wherein said identity is arranged to be mapped onto a cell-ID, so as to allow said identity to be determined by determining said cell-ID.

41. The system according to embodiment 40, wherein said cell-ID is arranged to be coded so that it is immediately decodable when said cell is detected by said user entity.

42. The system according to embodiment 40, wherein said cell-ID is arranged to be coded as a sequence on a synch channel.

43. The system according to embodiment 39, wherein said identity is arranged to be cell specific within said pattern.

44. The system according to any of the embodiments 37-43, wherein said pattern is arranged to be reused so that that the pattern is repeated a plurality of times.

45. The system according to embodiment 37, wherein a representation of said cell pattern is arranged to be signalled by at least one of said cells, so as to allow said user entity to determine the specific cell pattern to which one or more cells belong.

46. The system according to embodiment 37, wherein said cells are arranged to belong to at least two different cell patterns, and that identities of the cell patterns to which a specific cell belongs is arranged to be signalled to said user entity.

47. The system according to embodiment 46, wherein said identities are arranged to be mapped onto a cell-ID, so as to allow said identities to be determined by determining said cell-ID.

48. The system according to embodiment 46, wherein a single cell is arranged to belong to two or more cell patterns.

49. The system according to embodiment 46, wherein said cell patterns are arranged to constitute cell patterns of more than one cellular communication system.

50. The system according to embodiment 46, wherein said cell patterns are arranged to constitute cell patterns with cells of different frequencies.

51. The system according to embodiment 46, wherein said cell patterns are arranged to at least partially overlap geographically.

52. The system according to embodiment 46, wherein the cell is arranged to transmit its position in each pattern.

53. The system according to embodiment 37, wherein said cell pattern is arranged to comprise cells of different sizes.

54. The system according to embodiment 35, wherein said set of target cells is arranged to be ordered, said ordering being based on the suitability of said cells as a new serving cell.

55. The system according to embodiment 54, wherein the number of cells in said ordered set of target cells is arranged to be limited.

56. The system according to embodiment 21, wherein the number of cells in said set is arranged to be limited by the communication system.

57. The system according to embodiment 55 or 56, wherein the number of cells in said set is arranged to be limited by defining the maximum number of cells in the set and/or defining the maximum allowed distance to cells in the set.

58. The system according to embodiment 35, wherein said set of target cells is arranged to be a neighbour cell list.

59. The system according to embodiment 35, wherein said signals are arranged to include information regarding the geographical coverage area of said cells.

60. The system according to embodiment 59, wherein said information include one or more from the group: the shape of the cell, the radius of the coverage area of the cell, the vertical coverage of the cell.

61. The system according to embodiment 59, wherein said information includes a representation of the geographical location of a radio transmitter of each of said cells.

62. The system according to embodiment 59, wherein said representation of the geographical location of each of said cells is an absolute position of a radio transmitter of each of said cells.

63. The system according to embodiment 35, wherein said generated set of target cells is arranged to contain cells of more than one cellular communication system.

64. The system according to embodiment 35, wherein said generated set of target cells is arranged to contain cells of more than one cellular radio access technology.

65. The system according to embodiment 35, wherein said user terminal is arranged to be in idle or active mode.

66. The system according to embodiment 35, wherein it further comprises means for: transmitting said generated set of target cells to said serving cell.

67. The system according to embodiment 35, wherein it further comprises means for: selecting one of said cells of said generated set of target cells as a new serving cell.

68. A user entity for use in a cellular communication system, said communication system including a plurality of cells, each of said cells including at least one radio transmitter 804 of FIG. 8 for providing communication with at least one user entity in a coverage area, wherein the user entity comprises means for, when in a coverage area of said source cell:

receiving signals (via receiver 801) transmitted from at least one of said cells, wherein said signals from said cell include cell-specific data from which a representation of a relationship of said cell with respect to said source cell can be derived; and

generating a set of target cells in Generator 802 of said user entity, based on said signals transmitted from said at least one cell.

69. The user entity according to embodiment 68, wherein said signals include data from which a relative location of said cell with respect to said source cell can be derived.

70. The user entity according to embodiment 69, wherein it further comprises means for:

performing measurements with Measurement Equipment 803 (FIG. 8) on at least a subset of said set of target cells, and

transmitting (via Transmitter 804) said measurements to said serving cell.

71. A computer program, characterised in code means, which when run in a computer causes the computer to execute the method according to any of the embodiments 1-34.

72. A computer program product including a computer readable medium and a computer program according to embodiment 71, wherein said computer program is included in the computer readable medium.

73. The computer program product according to embodiment 72, wherein said computer readable medium consists of one or more from the group: ROM (Read-Only Memory), PROM (Programmable Read-Only Memory), EPROM (Erasable PROM), Flash memory, EEPROM (Electrically Erasable PROM), hard disk drive.

Although the present invention has been described in connection with an LTE system, the principles of the invention applies to cellular access systems in general, and are therefore applicable in any cellular system, such as, but not limited to, CDMA2000, UMTS & GSM

1-73. (canceled)

74. A method for generating a set of target cells suitable for a handover from a source cell in a cellular communication system, said communication system including a plurality of cells, each of said cells including at least one radio transmitter for providing communication with at least one user entity in a coverage area, wherein the method further comprises, in said user entity, when in a coverage area of said source cell:
receiving signals transmitted from at least one of said cells, wherein said signals from said cell include cell-specific data from which a representation of a relationship of said cell with respect to the source cell can be derived, and
generating a set of target cells in said user entity, based on said signals transmitted from said at least one cells.

75. The method according to claim 1, wherein said location of said cells are represented by a cell pattern, said cell pattern describing the relative location of said cells with respect to each other.

76. The method according to claim 2, wherein said signals transmitted from said cells comprise information from which the position of said cells in said cell pattern can be derived.

77. The method according to claim 3, wherein said information comprise an identity, said identity representing the position of said cells in said cell pattern.

78. The method according to claim 4, wherein said identity is mapped onto a cell-ID, so as to allow said identity to be determined by determining said cell-ID.

79. The method according to claim 2, wherein said pattern is reused so that that the pattern is repeated a plurality of times.

80. The method according to claim 2, wherein a representation of said cell pattern is signalled by at least one of said cells, so as to allow said user entity to determine the specific cell pattern to which one or more cells belong.

81. The method according to claim 2, wherein said cells belong to at least two different cell patterns, and that identities of the cell patterns to which a specific cell belongs is signalled to said user entity.

82. The method according to claim 8, wherein said cell patterns constitute cell patterns of more than one cellular communication system, or cell patterns with cells of different frequencies.

83. The method according to claim 1, wherein said set of target cells is a neighbour cell list.

84. The method according to claim 1, wherein said signals include information regarding the geographical coverage area of said cells.

85. The method according to claim 11, wherein said information regarding the geographical coverage area includes one or more of: the shape of the cell, the radius of the coverage area of the cell, the vertical coverage of the cell.

86. The method according to claim 1, wherein it further comprises selecting one of said cells of said generated set of target cells as a new serving cell.

87. A system for generating a set of target cells suitable for a handover from a source cell in a cellular communication system, said communication system including a plurality of cells, each of said cells including at least one radio transmitter for providing communication with at least one user entity in a coverage area, wherein the radio transmitter is arranged to transmit signals from at least one of said cells, wherein said signals from said cell include cell-specific data from which a representation of a relationship of said cell with respect to the source cell can be derived, so as to allow generation of a set of target cells in a user entity, based on said signals.

88. The system according to claim 14, wherein said location of said cells is arranged to be represented by a cell pattern, said cell pattern describing the relative location of said cells with respect to each other.

89. The system according to claim 15, wherein said signals transmitted from said cells are arranged to comprise information from which the position of said cells in said cell pattern can be derived from said information is arranged to comprise an identity, said identity representing the position of said cells in said cell pattern, and said identity is arranged to be mapped onto a cell-ID, so as to allow said identity to be determined by determining said cell-ID.

90. The system according to claim 15, wherein said pattern is arranged to be reused so that that the pattern is repeated a plurality of times.

91. The system according to claim 14, wherein said signals are arranged to include information regarding the geographical coverage area of said cells.

92. A user entity for use in a cellular communication system, said communication system including a plurality of cells, each of said cells including at least one radio transmitter for providing communication with at least one user entity in a coverage area, wherein the user entity comprises:
a receiver to receive signals transmitted from at least one of said cells, wherein said signals from said cell include cell-specific data from which a representation of a relationship of said cell with respect to said source cell can be derived; and
a generator of generating a set of target cells in said user entity, based on said signals transmitted from said at least one cell.

93. The user entity according to claim 19, wherein said signals comprise data from which a relative location of said cell with respect to said source cell can be derived, and the user entity comprises:
measurement equipment to measure on at least a subset of said set of target cells, and
a transmitter to transmit said measurements to said serving cell.
